(19) United States
(12) Patent Application Publication
(10) Pub. No.: US 2013/0129509 A1
(43) Pub. Date: May 23, 2013

(54) VERTICAL AXIS WIND TURBINE

(71) Applicant: Howard John Manning, Edinburgh (GB)

(72) Inventor: Howard John Manning, Edinburgh (GB)

(73) Assignee: AIRBORNE ENERGY LIMITED, Edinburgh (GB)

(21) Appl. No.: 13/698,415

(22) PCT Filed: May 26, 2011
(86) PCT No.: PCT/GB2011/000795

§ 371 Date: Jan. 7, 2013

(30) Foreign Application Priority Data
May 28, 2010 (GB) 1008920.9
Feb. 22, 2011 (GB) 1102993.1

(51) Int. Cl. F03D 3/06; F03D 3/04; F03D 3/00

(52) U.S. Cl. CPC F03D 3/068; F03D 3/005; F03D 3/04
USPC 416/17; 416/111; 415/4.4

(57) ABSTRACT

A vertical axis wind turbine with blades which articulate to reduce drag when they are moving upwind and which are suitable for use in small scale electrical generators. The turbine has blades which are rotatable about a blade axis of rotation and the blade axis is rotatable about a turbine axis of rotation. A vane is coupled to the blade axis of rotation to change the orientation of the blades in response to changes in wind direction. The vane maximizes the effect of the wind on the one or more blade by adjusting the blade position to maximize the blade surface area facing into the wind when the blade is moving downwind and to minimize the blade surface area facing into the wind when the blade is moving upwind.

### INTRODUCTION

The present invention relates to a vertical axis wind turbine and in particular to vertical axis wind turbines with blades which articulate to reduce drag when they are moving upwind and which are suitable for, but not limited to, use in small scale electrical generators.

### BACKGROUND

There are two main types of wind turbine, defined by the orientation of the axis of rotation of the components driven by the wind. Horizontal axis turbines have one or more blades attached to a central rotor whose axis is horizontal and aligned with the direction of the wind. Drag and lift forces on the blades, usually dominated by the latter, produce motion perpendicular to the wind, resulting in rotation. The speed at the tips of the blades usually exceeds the speed of the wind, typically by a factor of about six; this gives rise to noise, endangers birds, and may disturb radar signals. In high winds the speed of rotation may threaten to destroy the turbine, so many have blades which can be feathered, by rotating them about their own axes, to reduce the lift generated and therefore the speed of rotation. Others deliberately steer the axis of rotation away from the wind, and some even have brakes to slow the rotation. Some horizontal axis wind turbines are brought to a complete stop in precisely the high wind conditions when the greatest power could have been extracted.

In a horizontal axis wind turbine the axis of rotation is usually located at a distance above the ground sufficient to prevent the rotating blades striking the ground, people or objects on the ground. The axis of rotation may be positioned higher than is dictated by this requirement, in order to access the higher wind speeds which are found at some distance above the ground.

In a horizontal axis wind turbine the axis of rotation must be aligned, actively or passively, with the direction of the wind. If the wind direction shifts, the rotor/blade assembly must rotate to the new direction. In addition, the equipment which makes use of the energy from the wind, such as an electrical generator, is usually located at the altitude of the rotor. It is possible to locate the equipment at ground level but this requires gear or other transmission which must accommodate the steering of the rotor into the wind.

The design of large scale horizontal axis wind turbines has converged in recent decades to a typical arrangement, resembling a propeller with three slim blades attached to a horizontal rotor connected via a gearbox to a generator housed within a nacelle. The nacelle is mounted on top of a tall tower, which needs to be very strong, and the nacelle is steered by electric motors to face the wind.

The second main type of wind turbine has a vertical axis with blades arranged around the axis in an asymmetrical manner. Drag and lift forces on the blades produce rotation in a preferred direction about the vertical axis. Most vertical axis wind turbines produce rotation regardless of the wind direction, and are therefore advantageous when the wind shifts frequently or is turbulent, as it often is in an urban environment or when the wind is disturbed by nearby trees or other obstructions. A vertical axis is convenient because the electrical generator or other equipment using the rotational energy can easily be located at ground level, or at least below the blades.

The disadvantage of most vertical axis wind turbines is that the blades gain energy on the downwind half of their rotation but lose it on the upwind half. This can result in low efficiency of extraction of the energy of the wind in the area swept by the blades. This inefficiency is the primary reason why horizontal axis turbines are favoured at present despite their drawbacks.

A feature of many vertical axis turbines which is both advantageous and disadvantageous is that they rotate slowly, with the blades moving at a speed no higher than the wind speed. Thus they are safe, and produce modest noise and vibration. As they do not experience high blade rotation speeds which can cause damage in horizontal axis wind turbines, the structures themselves need not be constructed to withstand excessive speed and vibration and they can continue to generate electricity when the wind speed is high. This feature is particularly valuable given that the energy in the wind is proportional to the cube of wind speed.

A well-established vertical axis design is the Savonius turbine, which uses two or more large blades curved in such a way as to experience a high drag force when moving downwind, but not too much drag when moving upwind. The blades move at a speed somewhat lower than the wind speed, and the efficiency is low, but the design has high torque when stationary and can therefore start unaided.

Some vertical axis wind turbines try to address the issue of low efficiency by keeping the blades slim and shaping them so they experience lift rather than drag forces once they are rotating at speed. The Darrieus design has blades which resemble an egg-beater, which rotate at a speed higher than the wind speed. This design has efficiency comparable with horizontal axis turbines, but produces low torque when stationary and cannot start unaided. Variants of this design have the blades twisted into spirals, but the essential characteristics are unchanged. Further variants with straight vertical blades exhibit improved start-up torque but reduced efficiency.

The small scale wind energy market is dominated at present by small versions of the typical ‘propeller’ type horizontal axis turbine. This design, although optimised for large installations on favourable wind-farm sites, is much less appropriate for small-scale application in a domestic or light-industrial setting.

### SUMMARY OF THE INVENTION

In accordance with a first aspect of the invention there is provided a vertical axis wind turbine comprising:
one or more turbine blades being rotatable about a blade axis of rotation said blade axis being mounted for rotation about a turbine axis of rotation, and;
blade orientation means comprising a coupling which is connected between the blade axis of rotation and a vane axis which is coaxial with but decoupled from the turbine axis of rotation, such that, for a given wind direction, the blade orientation means maximises the effect of the wind on the one or more blade by adjusting the blade position to maximise the blade surface area facing into the wind when the blade is moving downwind and to minimise said blade surface area facing into the wind when the blade is moving upwind; and
a wind vane attached to the vane axis so as to change the overall orientation of the wind turbine in response to a change in wind direction to maintain the maximised performance of the one or more blade.

Preferably, the coupling moves the blades towards a position substantially perpendicular to the wind when they are on the downwind side of the turbine and moves the blades towards a position substantially parallel to the wind on the upwind side.

Preferably, the coupling is arranged to provide counter-rotation of the blades at half the rate of rotation of the frame.

Optionally, the coupling comprises a first wheel mounted upon the blade axis of rotation and a second wheel mounted on the vane axis which are connected by a closed loop circumferentially mounted on the wheels.

Optionally, the first wheel comprises a blade cog connected to the blade axis of rotation the second wheel comprises a central cog coaxially mounted on the vane axis and the closed loop comprises a belt with cog engaging means connected between the blade cog and central cog,

Optionally, the first wheel has a diameter twice that of the second wheel.

Optionally, the coupling comprises a belt drive.

Preferably, the belt drive comprises having a blade cog connected to the blade axis of rotation, a central cog coaxially mounted on the vane axis and a belt with cog engaging means connected between the blade cog and central cog,

Preferably, the wind vane is coupled to the central cog.

Preferably, the vertical axis wind turbine further comprises a frame upon which the one or more turbine blades and the central turbine axis are rotatably mounted and to which the wind vane and blade orientation means are fixed.

Preferably, the one or more turbine blades are radially displaced from the turbine axis of rotation.

Preferably, the wind vane is positioned inside the frame.

Preferably, the wind vane is positioned inside the radial and/or axial extent of the one or more blade.

Optionally, the wind vane is positioned inside the radial and/or axial footprint of the wind turbine.

Preferably, the wind vane is positioned asymmetrically on or near the frame with respect to the vane axis so that the vane remains downwind relative to any wind direction.

Preferably, the orientation of the wind vane relative to the belt drive is biased to compensate for the torque applied to the belt drive.

Preferably, the wind vane is shaped so as to deflect the wind in the direction of rotation of the frame.

Preferably, the wind vane is provided with dampening means to inhibit oscillation of the vane about an equilibrium position for a given wind direction.

Preferably the dampening means is a rotary dashpot.

Preferably, one or more turbine blade is symmetrical under 180 degree rotation about its blade axis

Optionally, the one or more turbine blade has a substantially flat profile

Optionally, the blade axis of rotation is tilted.

Optionally, the blade axis of rotation may be tilted radially and/or circumferentially.

Optionally, the turbine blade is of variable thickness.

Preferably, the turbine blade has a cross-sectional shape which produces lift forces which reinforce the rotation of the turbine.

Preferably, the vertical axis wind turbine further comprises an electrical generator.

Optionally, the vertical axis wind turbine further comprises an output shaft.

Optionally, the output shaft is rotatable at speeds higher than the frame.

Optionally, a single toothed belt engages with the blade cog, the central cog and also an accelerator pulley attached to the frame, wherein:
the rear of the belt may engage with one or more idler pulleys;
the accelerator pulley is attached coaxially to an accelerator gear;
the accelerator gear engages an output gear, coaxial with the turbine axis;
the output gear is attached coaxially to the output shaft.

Optionally, a two-sided toothed belt engages with the blade cog, the central cog and an accelerator pulley attached to the frame, wherein:
the accelerator pulley is attached coaxially to a second accelerator pulley;
the second accelerator pulley is linked by a further belt to an output pulley, coaxial with the turbine axis;
the output pulley is attached coaxially to the output shaft.

Optionally, a two-sided toothed belt and one or more single-sided toothed belts engage with the blade pulleys, the central pulleys and a third accelerator pulley attached to the frame, wherein:
the third accelerator pulley is attached coaxially to a fourth accelerator pulley;
the fourth accelerator pulley is linked by a further belt to an output pulley, coaxial with the turbine axis;
the output pulley is attached coaxially to the output shaft.

Preferably, the cogs and belts may be replaced by any combination of pulleys, belts, sprockets, chains, gears or other equipment to provide an output shaft rotating more rapidly than the frame.

Preferably, the frame is shaped to funnel wind onto the one or more blade.

Optionally, the vertical axis wind turbine comprises two frames each attached to one or more blades, counter-rotating about a common turbine axis.

The present invention is a vertical axis turbine intended for but not limited to small-scale applications. In one aspect of the invention, the shortcomings of the turbines in the prior art are addressed by having blades which are articulated as the turbine rotates, in such a way that the blades experience large drag forces when moving downwind, but minimise drag when moving upwind. Lift also contributes to the gathering of energy.

The turbine has one or more blades, preferably two, three or four, each able to rotate about its own substantially vertical axis. Each blade can be substantially rectangular, flat and symmetrical, having a cross-section designed to produce a large drag force when the wind is perpendicular to the face of the blade, but a low drag force when the wind is parallel to the blade in either direction.

Preferably, the blade axes are fixed to a frame which rotates about the vertical axis of the turbine as a whole. As the turbine rotates, the blades may be arranged to counter-rotate about their individual axes in a coordinated manner.

For example, when a given blade is moving downwind, it is oriented substantially perpendicular to the wind so it experiences a drag force tending to produce the desired rotation of the turbine. After half a revolution of the turbine as a whole, the blade has revolved only a quarter-turn and is therefore oriented parallel to the wind, so it can move upwind with a minimum of drag.

When the turbine has completed one revolution, the blade is back on the downwind side, again oriented perpendicular to the wind, but in an orientation half a turn from its original position. After two turbine revolutions, the blade is back in the original position and orientation.

When the blade is in intermediate positions, it is in intermediate orientations determined by equipment which counter-rotates the blade about its own axis at precisely half the rotational speed of the turbine as a whole. This has the effect of keeping the blade broadly perpendicular to the wind when it is on the downwind side of the turbine, and broadly parallel to the wind when it is on the upwind side. The blade experiences drag and lift forces in such a way that it is able to gather the energy of the wind for considerably more than half of the turbine's rotation.

If there are multiple blades, each one may behave in the manner described above, so there is a tendency for the turbine to rotate in the preferred direction, driven by most of the blades most of the time. It is also desirable, particularly in small low-cost applications that the mechanism for organising blade orientation works passively rather than demanding active control such as a motor-driven mechanism responding under electronic control to a wind direction sensor.

Another aspect of the present invention is that the rate of rotation of the turbine, which increases with wind speed, self-limits passively at high wind speeds so it is not necessary to have active controls to limit speed or stop the turbine.

It is difficult to generate electricity from the slow rotation produced by vertical axis wind turbines. The present invention can use a large-diameter disc-shaped generator, which produces a high speed at the periphery despite the low rotation rate, which is helpful for the generation of electricity. A further aspect of the present invention is the possibility of providing by an output shaft rotating at a higher speed then the turbine as a whole, permitting the use of a conventional small-diameter generator designed for high rotational speeds, without destroying the self-starting advantage of the basic design and without incurring the hazard of exposing large parts of the turbine to high speeds.

### BRIEF DESCRIPTION OF THE DRAWINGS

The present invention will be described by way of example only with reference to the accompanying drawings in which:

FIGS. 1a, 1b and 1c show in schematic plan views of a first embodiment of a wind turbine in accordance with the present invention;

FIG. 2 shows a side view perpendicular to the direction of the wind of the first embodiment of the present invention;

FIG. 3a is a perspective view of an embodiment of the present invention similar to that shown schematically in FIGS. 1a, 1b, 1c and 2, FIG. 3b is a close-up perspective view of the coupling between the vane and blade axes;

FIGS. 4a and 4b are schematic views of a means of providing an output at higher speed than the turbine as a whole in accordance with the present invention;

FIG. 5 is a schematic view of an alternative means of providing a high speed output; and

FIG. 6 a schematic view of a further alternative means of providing high speed output.

### DETAILED DESCRIPTION OF THE DRAWINGS

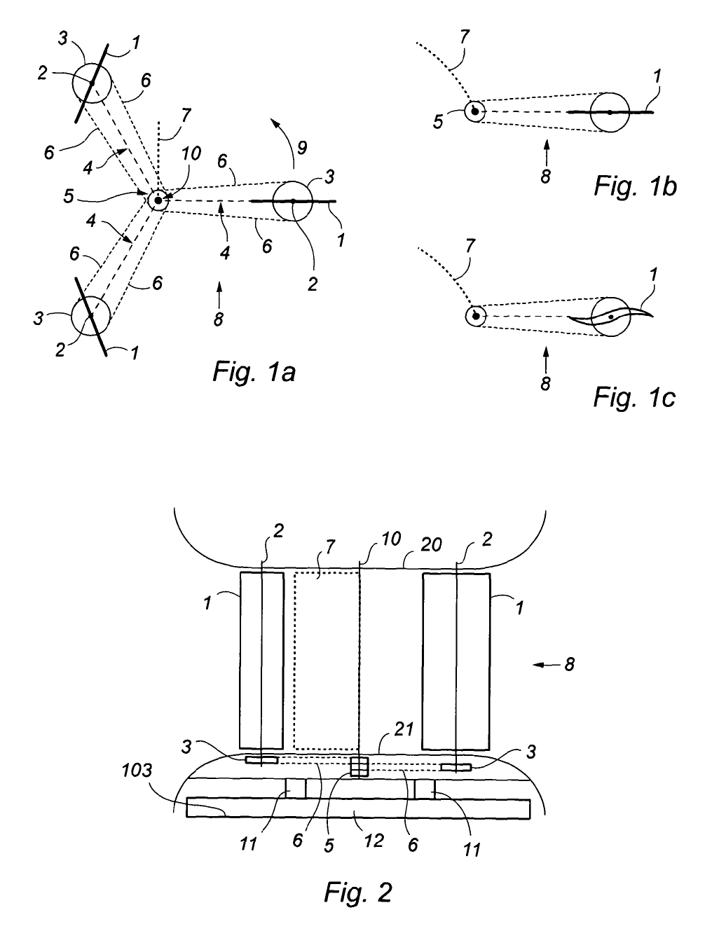

Referring to FIG. 1a, the wind turbine is shown schematically in plan view. Blades 1 (shown as heavy lines), substantially rectangular, vertical, flat and symmetrical, are the primary elements which capture the energy of the wind. There may be one or more blades, but preferred numbers are two, three or four; three are shown. Each blade is attached to a substantially vertical blade axis 2 (shown as a small dot) with the blades projecting equally on either side. The coupling means connects the lower ends of the blade axes by means of a wheel and loop coupling which in this example comprises a belt drive arrangement also referred to as blade pulleys 3 (shown as large open circles); each blade assembly, consisting of blade, blade axis and blade pulley, can rotate about its own axis.

The blade assemblies are shown schematically attached to each other, preferably symmetrically, by a frame 4 (shown as long dashed lines) whose components meet at a substantially vertical turbine axis 10 (shown as a large dot). The frame 4 can rotate about the turbine axis, carrying the blade assemblies with it.

With the wind in the direction shown by the straight arrow 8, the blade at the right-hand side is oriented perpendicular to the wind and experiences a drag force producing rotation of the frame 4 in the direction shown by the curved arrow 9. The speed of the blade will be a substantial fraction of the wind speed.

The other two blades shown are oriented so as to minimise drag as they move upwind. Indeed if the turbine were rotating at fully the speed of the wind, the blades on the upwind side would be oriented precisely parallel to the net wind (the vector sum of the wind and the motion of the blades). With the turbine moving at a substantial fraction of wind speed, the upwind blades are oriented close to parallel to the net wind, so drag is minimal.

As the frame 4 rotates, the blades occupy, in turn, the positions shown and intermediate positions, which maintain the blades broadly perpendicular to the net wind on the downwind side of the turbine and broadly parallel on the upwind side. At low rates of rotation of the frame 4, such as at startup when the wind has just increased in speed, the drag force on the downwind blades is high and the opposing drag on the upwind blades is modest, so the turbine has a high torque available for start-up. At high rates of rotation of the frame 4, when it has reached operating speed in a given wind, the blades experience a mixture of drag and lift forces in such a way that they contribute to the gathering of the wind's energy for more than half of the turbine revolution.

Thus the turbine has a preferred sense of rotation, starts up easily and gathers the energy of the wind with high efficiency.

Coordination of the blade orientation is achieved passively as follows. The belt drive comprises one or more central pulleys 5 (shown as a small circle) are located at the bottom of the turbine axis, coaxial with it but not rotating with the frame 4. The central pulleys 5 remain stationary provided the wind direction remains constant. Each blade pulley is linked to a central pulley by a belt 6 (shown by short dashed lines). The central pulleys have half the number of teeth that the blade pulleys have, and the belts are engaged on the pulleys in such a way as to produce the blades orientations shown.

As the frame 4 rotates, the fact that the belts are attached to the stationary central pulleys causes the blade pulleys to rotate clockwise about their individual blade axes at half the rotational speed of the frame 4. This produces the illustrated blade orientations.

After one full revolution of the frame, each blade is back in its original position, but rotated 180 degrees about its blade axis relative to its original orientation. After a further revolution of the frame, the blades are again in their original positions but also in their original orientations. Where the blades must operate correctly both after one revolution and after two demands that the blades are symmetrical under 180 degree rotation about the blade axes.

The present invention achieves passive control of the position of the central pulleys as follows: the fact that the central pulleys do not rotate with the turbine while the wind direction remains constant is ensured by a vane 7 (shown as a heavy dotted line), attached to the central pulleys, which tends to remain downwind as shown. It is convenient if the vane is located within the frame. It may be advantageous if the vane is curved so as to deflect the wind in the direction of rotation of the frame, as shown in FIG. 1b.

If the wind direction shifts, the vane causes the central pulleys to rotate to the new wind position and stabilise there. The belts then cause the blades to behave in the manner described above with respect to the new wind direction. Both the coordination of blade orientation (as the frame rotates with wind direction fixed) and the accommodation to varying wind direction are achieved passively, using the energy of the wind, without external intervention. This is particularly advantageous in circumstances, such as an urban installation, where the wind shifts direction frequently and is turbulent.

It may be that the vane tends to oscillate about the equilibrium position for a given wind direction, impairing the coordination of the blades. If the amplitude of the oscillation is large the vane may fail to return to the equilibrium position and instead undergo a complete rotation; it then takes some time for blade coordination to recover, and if this occurs repeatedly the rotation of the turbine is slowed. In one embodiment of the present invention, vane oscillations are inhibited using a damper such as a rotary dashpot, which resists rotation of the vane by applying to it a restoring torque which is dependent on the speed of rotation, but applies no torque when the vane is stationary.

The rotation rate of the frame cannot become excessive as the blades, even when moving downwind, will not move faster than the wind, and indeed will move at a fraction of the wind speed which is determined by details of aerodynamics of the blades, friction in the transmission and the load applied by the electrical generator.

The torque applied via the belts to the central pulleys and therefore the turbine axis produces a slight rotation of the vane, in the same direction as the frame rotation, which threatens to spoil the coordination of blade orientations. This can be countered by attaching the vane to the central pulleys with an angular offset. The vane will take up an equilibrium position in which the torque applied by the wind passing the vane balances the torque applied via the belts. FIG. 1b shows the vane 7 in an offset equilibrium orientation such that the downwind blade 1 is oriented perpendicular to the wind direction 8.

The angular offset of the vane will be precise only at one wind speed; the error which develops at higher speeds is advantageous because its effect on blade orientations causes the frame speed to self-limit. The self-limiting of the already low speed inherent in the design obviates the need to provide active limitation or even shut-down of the turbine in precisely the windy conditions most valuable for generation of electricity.

The cross-section of the blades can be shaped, within the constraint that they must be symmetrical under rotation by 180° about the blade axes, to improve performance. Blades which are thin at the vertical edges and thicker near the blade axes are sufficiently stiff to withstand the drag forces when perpendicular to the wind but sufficiently aerodynamic to move with minimal drag parallel to the wind. FIG. 1c shows a blade with each half having an aerofoil section, such that lift forces on the blades tend to rotate them about their axes in the required direction, and also tend to reinforce the rotation of the turbine as a whole.

In use, the turbine starts at a low wind speed; rotates steadily in the preferred direction over a range of wind speeds; the vanes oscillate only slightly; the tips of the blades move more slowly than the wind; the turbine responds correctly to changes in wind direction, without the vane performing an unwanted rotation. If the orientation of the blades and vanes is unfavourable when the wind starts, they organise themselves correctly within a short time.

FIG. 2 shows a side view perpendicular to the direction of the wind 8. Two of the blades 1 are shown, attached to their axes 2 and blade pulleys 3 at the bottom. Belts 6 connect the blade pulleys to the central pulleys 5, which are held stationary by the vane 7, shown in a downwind position relative to the wind direction.

Part of the frame 4 (FIG. 1) is shown as a cross-brace 20 between the tops of the blade axes and turbine axis, and part of the frame is a box 21 at the bottom, housing the pulleys and belts. These may take the form of disks, circular in plan view, curved upwards in the case of cross-brace 20 and downwards in the case of box 21, in order to concentrate the wind onto the blades from altitudes respectively above and below the blades. Additional cross-braces can be provided at intermediate heights. If the blades twist, one or more of the cross-braces takes the form of an additional box housing pulleys and belts.

In this embodiment of the invention power is provided by the relative motion of the rotating box 21 and a stationary electrical generator box 12 at the bottom. Alternatively a central output shaft can deliver power from box 21 to box 12. As both boxes are of large diameter, one or more large bearings 11 can be used to support box 21 and therefore the turbine as a whole against the sideways force of the wind. The generator can occupy a space of large diameter, with magnets and coils around the outer edge, yielding a high relative speed for efficient generation of electricity.

This design can be adapted for mounting around a pre-existing vertical pole such as a street lamp or a mobile telephone mast; the pole acts as the turbine axis, and the central pulleys are large enough to surround it.

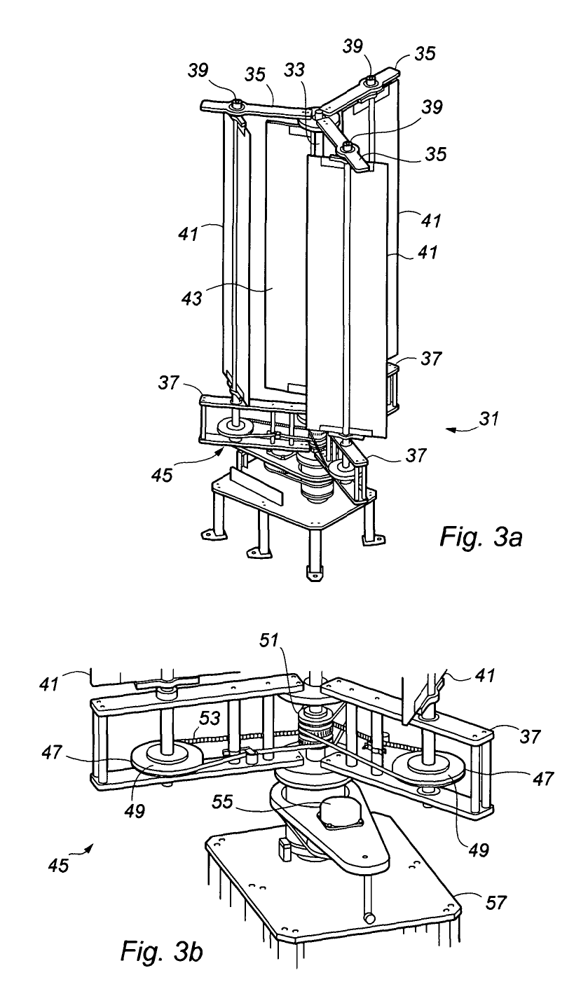

FIG. 3a is a perspective view of an embodiment of the present invention similar to that shown schematically in FIGS. 1a, 1b, 1c and 2, The vertical axis wind turbine 31 comprises a central turbine axis 33 with radially extending supports 35 at the top and towards the bottom of the turbine 35 and 37 respectively. The blade axes of rotation 39 extend between the supports 35, 37 and the blades 41 which are substantially planar. Each blade extends substantially symmetrically either side of the blade axis of rotation 39. The orientation of each blade 41 relative to the supports 35, 39 is determined by the position of the vane 43 and the coupling mechanism 45 which positions the blades in response to the position of the vane as determined by the wind direction. The vane is coupled to the vane axis but is not coupled to the rotation of the turbine as a whole.

FIG. 3b shows in close-up the coupling mechanism 45 which comprises pulleys 47 located below the top member of the lower support. The pulley comprises a wheel 49 coupled to the blade axis 39, and a second wheel 51 coupled to the vane axis 33 (FIG. 3a). A toothed transmission belt 53 couples together the first and second wheels such that a change in the vane position is transmitted to the blades 41 in order to change their orientation. A suitable generator is shown generally at 55 for conversion of the rotational energy from the turbine into electricity and is situated on base 57 to ensure the blades are positioned a suitable height above ground level.

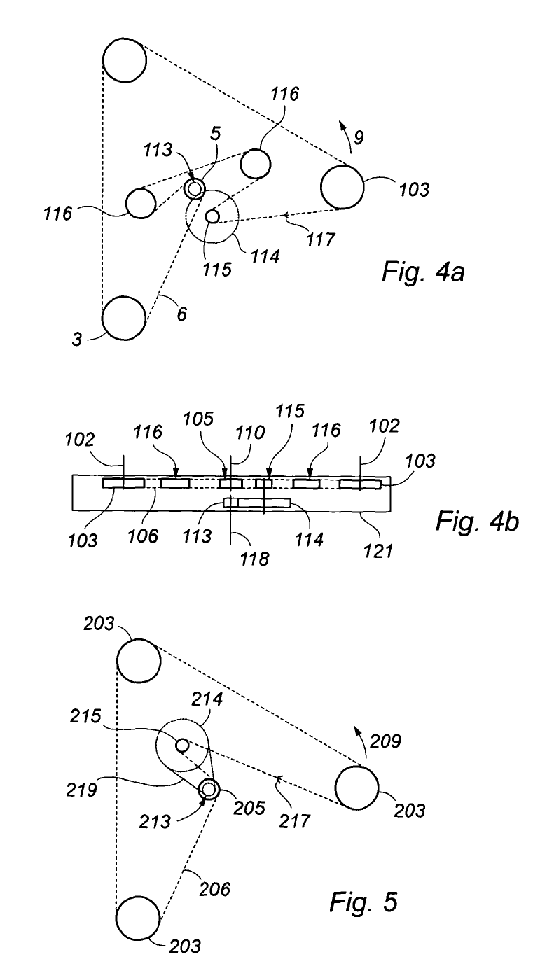

FIGS. 4a and 4b show another embodiment of the present invention which provides a means of providing an output at higher rotational speed than that of the turbine as a whole. In FIG. 4a the transmission is shown in plan view. There is still one blade pulley 103 for each blade, but there is now only one central pulley 105 coaxial with the turbine axis and one belt 106. The two-to-one speed ratio between the turbine as a whole and the counter-rotation of the blades is established by the fact that the belt passes from one of the blade pulleys to the central pulley. The belt engages an accelerator pulley 115 and may also pass round one or more idler pulleys 116 which touch the non-toothed rear of the belt.

FIG. 4b shows a side view of rotating box 121. All the blade pulleys (two shown), the central pulley, the accelerator pulley and the idler pulleys are coplanar, fixed relative to one another, and rotate as a group with the box. Also in the box, below the pulleys, are an accelerator gear 114 (fixed to a shaft common with the accelerator pulley) and an output gear 113 on an output shaft 118 which is coaxial with but separate from the turbine axis. The teeth of the accelerator gear and the output gear are engaged; the accelerator gear rotates with the box.

In FIG. 4a, arrow 117 shows the direction of belt travel relative to the group of pulleys. The output shaft rotates anticlockwise both because the accelerator gear travels anticlockwise around the output gear and also because the belt motion causes the accelerator gear to rotate clockwise about its own axis. If the central pulley has N teeth, the blade pulleys have 2N teeth, the accelerator pulley has m teeth, the accelerator gear has M teeth and the output gear has n teeth, it can be shown that the output shaft rotates at a speed larger than that of the turbine as a whole by a factor [1+MN/(mn)]. The various numbers can be adjusted to make this factor convenient for the generation of electricity.

FIG. 5 shows another embodiment of the present invention which provides an alternative means of providing an output at higher rotational speed than that of the turbine as a whole. There are now two toothed belts: a two-sided blade belt 206 engages the blade pulleys 203, the central pulley 205 and a third (small) accelerator pulley 15, all of these being coplanar and attached to the box. Below, shown in dotted lines, there is a fourth (large) accelerator pulley 214 (coaxial with the small accelerator pulley) and an output belt pulley 213, connected by an output belt 219. All of these components are fixed to the box and rotate with it. This scheme achieves the same speed increase as that in FIG. 4.

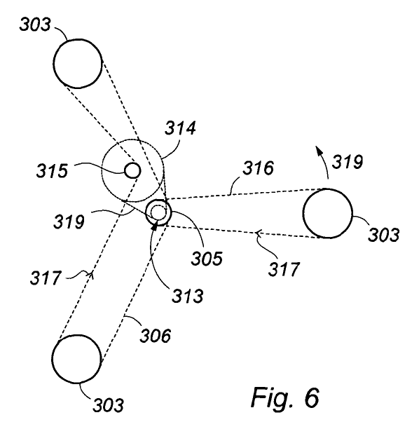

FIG. 6 shows another embodiment of the present invention which provides a further alternative means of providing an output at higher rotational speed than that of the turbine as a whole. Now two toothed belts 306 (one single-sided and one two-sided) engage the blade pulleys 303, central pulleys 305 and small accelerator pulley 15, all of these being coplanar and attached to the box. Below, shown in dotted lines, there is a large accelerator pulley 314 (coaxial with the small accelerator pulley) and an output belt pulley 313, connected by an output belt 319. All of these components are fixed to the box and rotate with it. This scheme permits the box to consist of a small central part, housing the central pulleys, accelerator pulleys and output pulley, and long narrow radial parts joining the central part to the blade pulleys; such a box can be both stronger and lighter than the large box required in FIGS. 4 and 5. This scheme achieves the same speed increase as that in FIGS. 4 and 5.

Many variations of the designs described above are possible. Timing belts and pulleys can be replaced by chains and sprockets, or by gears, or any combination thereof; the essential feature is the two-to-one relationship between the rates of rotation of the frame and the counter-rotation of the blades.

The number of blades can be varied—two reduces cost and avoids the possibility of stationary balanced positions, but may be less efficient, while four produces more torque and may be more efficient.

The blades need not be rectangular in side view; they could be wider at the top, where the wind speed is higher, or curved at the top or bottom, for example to combat vortices.

The blade axes need not be vertical; they may lean radially outwards at the top, for example in order to permit the blades to be wider at the top, or outwards at the bottom, for example to permit an overall turbine structure which is broad at the bottom in order to resist wind loads. The blade axes may lean circumferentially towards the direction of rotation at the top, for example to produce an element of downward force on the blades, or against the rotation for aerodynamic reasons.

The blades may be made of many materials, for example metal, plastic, glass fibre, carbon fibre, wood, or of composite construction. Considerations include strength; avoidance of fatigue under alternating forces; non-conducting material to avoid disturbance to radio signals; weight; wear and ease of repair and replacement; reflectivity, colour and aesthetics; environmental impact and recyclability; and cost.

The vane may be within the swept volume of the blades, above the blades, outside the swept volume of the blades or a combination of these. Part of the vane outside the swept volume could shield the blades on the upwind side of the turbine.

The turbine has a preferred direction of rotation; this may be clockwise or anticlockwise to suit the electrical generator.

The torque applied to the turbine axis could be reduced by providing two frames, each attached to one or more blades, counter-rotating about a common turbine axis.

Improvements and modifications may be incorporated herein without deviating from the scope of the invention.

1. A vertical axis wind turbine comprising:
one or more turbine blades being rotatable about a blade axis of rotation said blade axis being mounted for rotation about a turbine axis of rotation, and;
blade orientation means comprising a coupling which is connected between the blade axis of rotation and a vane axis which is coaxial with but decoupled from the turbine axis of rotation, such that, for a given wind direction, the blade orientation means maximises the effect of the wind on the one or more blade by adjusting the blade position to maximise the blade surface area facing into the wind when the blade is moving downwind and to minimise said blade surface area facing into the wind when the blade is moving upwind; and
a wind vane attached to the vane axis so as to change the overall orientation of the wind turbine in response to a change in wind direction to maintain the maximised performance of the one or more blade,
wherein the coupling comprises a first wheel mounted upon the blade axis of rotation and a second wheel mounted on the vane axis which are connected by a closed loop circumferentially mounted on the wheels and a belt drive and the orientation of the wind vane relative to the belt drive is biased to compensate for the torque applied to the belt drive.

2. A vertical axis wind turbine as claimed in claim 1 wherein, the coupling aligns the blades substantially perpendicular to the wind when they are on the downwind side of the turbine and substantially parallel to the wind on the upwind side.

3. A vertical axis wind turbine as claimed in claim 1 wherein, the coupling is arranged to provide counter-rotation of the blades at half the rate of rotation of the frame.

4. (canceled)

5. A vertical axis wind turbine as claimed in claim 1 wherein, the first wheel comprises a blade cog connected to the blade axis of rotation the second wheel comprises a central cog coaxially mounted on the vane axis and the closed loop comprises a belt with cog engaging means connected between the blade cog and central cog,

6. A vertical axis wind turbine as claimed in claim 5 wherein, the first wheel has a diameter twice that of the second wheel.

7. (canceled)

8. A wind turbine as claimed in claim 6 wherein, the wind vane is coupled to the second wheel.

9. A wind turbine as claimed in claim 1 further comprising a frame upon which the one or more turbine blades and the central turbine axis are rotatably mounted and to which the wind vane and blade orientation means are fixed.

10. A wind turbine as claimed in claim 1 wherein, the wind vane is positioned inside the frame.

11. A wind turbine as claimed in claim 1 wherein, the wind vane is positioned inside the radial and/or axial extent of the one or more blade.

12. A wind turbine as claimed in claim 10 wherein, the wind vane is positioned asymmetrically on or near the frame with respect to the vane axis so that the vane remains downwind relative to any wind direction.

13. (canceled)

14. A wind turbine as claimed in claim 1, the wind vane is shaped so as to deflect the wind in the direction of rotation of the frame.

15. A wind turbine as claimed in claim 1 wherein, the wind vane is provided with dampening means to inhibit oscillation of the vane about an equilibrium position for a given wind direction.

16. A wind turbine as claimed in claim 15 wherein, the dampening means is a rotary dashpot.

17. A wind turbine as claimed in claim 1 wherein the one or more turbine blade is symmetrical under 180 degree rotation about its blade axis.

18. A wind turbine as claimed in claim 1 wherein, the one or more turbine blade has a substantially flat profile

19. A wind turbine as claimed in claim 1 wherein, the blade axis of rotation is tilted.

20. A wind turbine as claimed in claim 19 wherein, the blade axis of rotation may be tilted radially and/or circumferentially.

21. A wind turbine as claimed in claim 20 wherein, the turbine blade has a cross-sectional shape which produces lift forces which reinforce the rotation of the turbine.

22. A wind turbine as claimed in claim 1 further comprising an electrical generator.

23. A wind turbine as claimed in claim 1 further comprising an output shaft.

24. A wind turbine as claimed in claim 1 wherein, a single toothed belt engages with the blade cog, the central cog and also an accelerator pulley attached to the frame, wherein:
the rear of the belt may engage with one or more idler pulleys;
the accelerator pulley is attached coaxially to an accelerator gear;
the accelerator gear engages an output gear, coaxial with the turbine axis;
the output gear is attached coaxially to the output shaft.

25. A wind turbine as claimed in claim 1 wherein, a two-sided toothed belt engages with the blade cog, the central cog and an accelerator pulley attached to the frame, wherein:
the accelerator pulley is attached coaxially to a second accelerator pulley;
the second accelerator pulley is linked by a further belt to an output pulley, coaxial with the turbine axis;
the output pulley is attached coaxially to the output shaft.

26. A wind turbine as claimed in claim 1 wherein a two-sided toothed belt and one or more single-sided toothed belts engage with the blade pulleys, the central pulleys and a third accelerator pulley attached to the frame, wherein:
the third accelerator pulley is attached coaxially to a fourth accelerator pulley;
the fourth accelerator pulley is linked by a further belt to an output pulley, coaxial with the turbine axis;
the output pulley is attached coaxially to the output shaft.

27. A wind turbine as claimed in claim 1 wherein, the frame is shaped to funnel wind onto the one or more blade.

28. A wind turbine as claimed in claim 1 wherein, the vertical axis wind turbine comprises two frames each attached to one or more blades, counter-rotating about a common turbine axis.
